(19) United States
(12) Patent Application Publication
(10) Pub. No.: US 2019/0355179 A1
(43) Pub. Date: Nov. 21, 2019

(54) TELEPRESENCE

(71) Applicant: HEWLETT-PACKARD DEVELOPMENT COMPANY, L.P., Spring, TX (US)

(72) Inventors: Marcio Bortolini, Porto Alegre (BR); Marcio Bortolini, Porto Alegre (BR); Rodrigo Teles Hermeto, Porto Alegre (BR)

(73) Assignee: HEWLETT-PACKARD DEVELOPMENT COMPANY, L.P., Spring, TX (US)

(21) Appl. No.: 16/479,348

(22) PCT Filed: Jan. 19, 2017
(86) PCT No.: PCT/US2017/014140

§ 371 Date: Jul. 19, 2019

(51) Int. Cl. G06T 19/00; H04N 7/14; H04N 7/15

(52) U.S. Cl. CPC G06T 19/006; H04N 7/157; H04N 7/142; H04N 7/147

(57) ABSTRACT

Some examples include a telepresence system including a mobile location device and a head mounted display assembly to visualize an image representing a first user within a second user's environmental surroundings based on orientation toward the mobile location device. The head mounted display assembly communicates with a video conferencing device via a wireless communication system.

### BACKGROUND

Telepresence systems can allow a first user at a first remote location to interface with a second user at a second location, allowing the remote user to feel as if they are present, at the same location as that of the second user.

### BRIEF DESCRIPTION OF THE DRAWINGS

FIG. 1 is a diagrammatic view of a telepresence system including a mobile location device and head mounted display assembly according to an example of the present disclosure.

FIG. 2 is a diagrammatic view of an example head mounted display assembly useful in the telepresence system of FIG. 1 in accordance with aspects of the present disclosure.

FIG. 3 is a diagrammatic view of an example mobile location device useful in the telepresence system of FIG. 1 in accordance with aspects of the present disclosure.

FIG. 4A is an illustration of an example mobile location device in example environmental surroundings.

FIG. 4B is an illustration of the mobile location device in the environmental surroundings of FIG. 4A as viewed by a user wearing a head mounted display assembly in accordance with aspects of the present disclosure.

FIG. 5A is another illustration of an example mobile location device in example environmental surroundings.

FIG. 5B is an illustration of the mobile location device in the example environmental surroundings of FIG. 5A as viewed by a user wearing a head mounted display assembly in accordance with aspects of the present disclosure.

FIG. 6 is a flow chart of an example method of operating a telepresence system in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Telepresence systems can provide a remote user with the ability to feel fully present and engaged with one or more participants at another location, physically separate from the location of the remote user and for the participants to feel engaged with the remote user as if the remote user were physically present. Virtual or augmented reality involves the concept of presence, or the experience of a user's physical environment, not to one's surrounding as they exist in the physical world, but to the perception of those surroundings as mediated by both automatic and controlled processes. Presence is defined as the sense of being in an environment. Telepresence is defined as the experience of presence in an environment by means of a communication medium. In other words, “presence” refers to the natural perception of an environment, and “telepresence” refers to the mediated perception of an environment. The environment can be either a temporally or spatially distant “real” environment, for instance, a distant space viewed through a camera. Telepresence is the experience of being present in a real world location remote from one's own physical location. The remote user can interactively participate in the real world location.

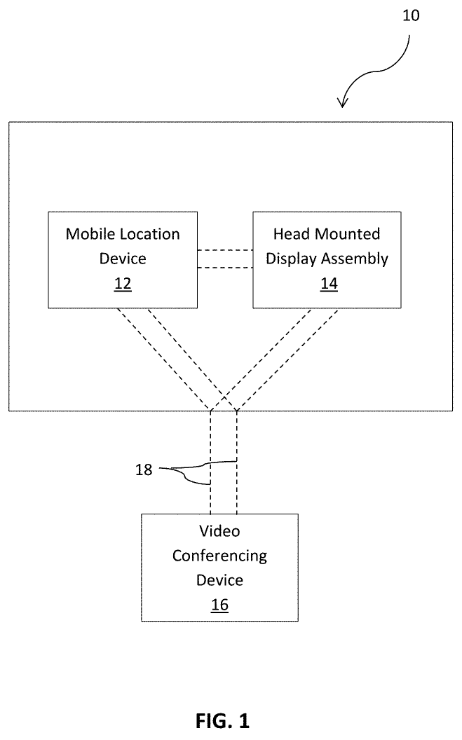

FIG. 1 is a diagrammatic illustration of a telepresence system 10 in accordance with aspects of the present disclosure. Telepresence system 10 includes a mobile location device 12 and a head mounted display assembly 14. Head mounted display assembly 14 is employed to visualize an image, such as an image representing a first remote user, within a second user's environmental surroundings when orientated toward mobile location device 12. Mobile location device 12 can provide mobility to telepresence system 10 into and within various locations and environments. Telepresence system 10 is not limited to a first remote user and a second user and multiple users can interact and participate in telepresence system 10. Telepresence system 10 can provide an interface of the users in different locations remote to one another, allowing the users to feel as if they are present at the same location as that of one of the users by providing video and audio teleconferencing systems with the ability to interface electronically. Telepresence system 10 provides image based communication between a user wearing head mounted display assembly 14 and in proximity with mobile location device 12 and a remote user in proximity to video conferencing device 16. Telepresence system 10 communicates with a video conferencing device 16 via a wireless communication system 18 as indicated by dashed lines and as described further below.

Communication system 18 enables first remote user employing video conferencing device 16 at a first remote location to electronically communicate with second user employing telepresence system 10 at a second location. Communication system 18 can include wired or wireless communication links, such as satellite communication links, to transmit data, audio, and/or video between video conferencing device 16, mobile location device 12, and head mounted display assembly 14 as indicated by dashed lines in FIG. 1. Communication between head mounted display assembly 14, mobile location device 12, and video conferencing device 16 can include network server(s) and satellite(s) to wirelessly transmit communication signals. Video conferencing device 16, mobile location device 12, and head mounted display assembly 14 can each include transmitters and receivers for sending and receiving data, video, and/or audio communication. Continuous and real-time streaming of video, audio and data can be employed. Processing of data, video, and/or audio communication can be independently performed at each of video conferencing device 16, mobile location device 12, and head mounted display assembly 14. In an example, head mounted display assembly 14 may route communications between the mobile location device 12 and video conferencing device 16, which may not be communicatively coupled directly to each other. In an example, the mobile location device 12 may route communications between the head mounted display assembly 14 and the video conferencing device 16, which may not be communicatively coupled directly to each other.

The image generated by video conferencing device 16 can be a virtual character (e.g., avatar) that graphically represents a first user, having features and characteristics selected by first user. The virtual character can be an existent or newly generated icon or figure. An icon or figure image can be generated as a video graphic. The image can be generated in three-dimensional (3D) form or two-dimensional (2D) form. A user can select or pre-record various visual physical aspects of the avatar image including facial and body types and movements or actions such as specific facial expressions (e.g., smile) or physical movements (e.g., bow) to replicate actions or expressions of the remote user. The user can also record some audio, such as a voice greeting, for example. Selected audio and video graphic characteristics of the virtual character can be generated by a processor and saved in a memory of video conferencing device 16. In an example, video conferencing device 16 includes one or more video capture devices (e.g., cameras) to capture and generate 2D or 3D images of the first user for communication to head mounted display assembly 14.

Head mounted display assembly 14, mobile location device 12, and video conferencing device 16 can each include a set or subset of these components including: processor; multicore processor, graphics processor; display; high definition display; liquid crystal display (LCD), light-emitting diode (LED), see-through LED, see-through mirror display, see-through LCD/LED mirror display or other displays; dual displays for each eye; programmable buttons; microphone; noise isolation or cancellation; speakerphone; in-ear speaker; digital still camera; digital video camera; front facing camera; back facing camera; side facing camera; eye tracking camera; high definition (HD, 720p, 1020p, 4K) camera; fight/flash; laser, projector; infrared or proximity sensor; vibration device; LEDs; light sensor accelerometer x-y-z positioning; global positioning system (GPS); compass; memory; power source such as battery or rechargeable battery; multiple data and video input and output ports; wireless transmit and receive modules; programming and operating information; antennas; operating system; lens. Each of head mounted display assembly 14, mobile location device 12, and video conferencing device 16 can broadcast using radio-frequency identification (RFID) to transmit identifying information to the other devices. RFIDs can be affixed or otherwise mounted.

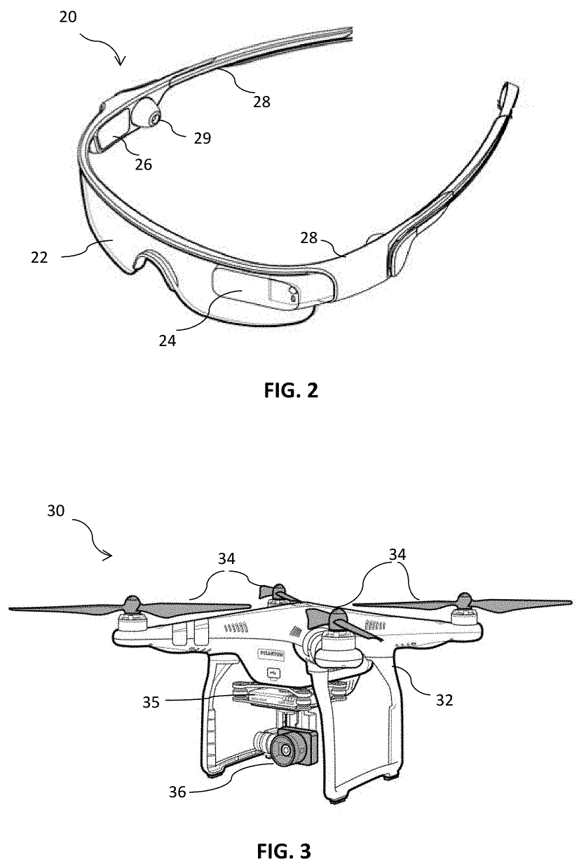

FIG. 2 illustrates a head mounted display assembly 20 useful in a telepresence system 10 according to one example of the present disclosure. Head mounted display assembly 20 includes an optical assembly 22, an image source 24, and a processor 26. A user can view at least a portion of a local real surrounding environment in which the user is present and an image received from a remote user through head mounted display assembly 20. A user can mount head mounted display assembly 20 onto the user's head with optical assembly 22 positioned in front of the user's eyes and aligned within the user's field of view. Head mounted display assembly 20 can be a goggles/eyeglasses type device that is worn the way a pair of goggles or eyeglasses are worn, or head mounted display assembly can be a helmet-mounted assembly that is attached to a helmet that is worn on the user's head. Head mounted display assembly 20 can include a frame 28 to house and maintain optical assembly 22, image source 24, and processor 26. Frame 28 is shaped and sized to removable retain head mounted display assembly 20 on the user's head and optical assembly 22 within the user's field of view.

Processor 26 is integrated into head mounted display assembly 20 to handle image content received from video conferencing device 16 (see, e.g., FIG. 1) for display to the second user. Image source 24 is integrated into head mounted display assembly 20 to introduce image content to image source 24. Image source 24 introduces image content for display through optical assembly 22. Image source 24 can be a nano-projector, or micro-projector, including a light source, for example. In some examples, head mounted display assembly 20 can project an image onto an object (e.g., mobile location device) or into a space (e.g., adjacent to mobile location device) in the form of a hologram, for example. Techniques/processes stored in a memory of head mounted display assembly 20 are processed in processor 26 to identify mobile location device and associate an image, or group of images, to mobile location device. Techniques are processed in head mounted display assembly 20 to form and project a hologram in accordance with the image generated via video conferencing device and associated with the remote user. Image content is processed and adjustment techniques performed with processor 26 to display image in a proportioned size (i.e., scaled) and spatial relationship within the environmental surroundings. For example, a distance between mobile location device and head mounted display assembly 20 can be continuously or periodically processed by processor 26 and display of image content adjusted accordingly.

In one example, head mounted display assembly 20 can be an optical see-through assembly that can combine computer-generated virtual images (e.g., avatar) with the views of a real-world environmental surroundings for an augment reality experience. For example, through use of an optical combiner, head mounted display assembly 20 can maintain a direct view of the physical world and optically superimpose generated images onto the real real-world environmental scene. Head mounted display assembly 20 is communicatively coupled to, and interactive with, mobile location device to display image content in a location, or position, relative to mobile location device. In some examples, upon orientation toward mobile location device, image content is introduced through optical assembly 22 via image source 24 onto mobile location device. In an example, the head mounted display assembly may capture video of the user's environment and display the captured video to the second user. The head mounted display assembly may insert images of or images representing the first user.

Head mounted display assembly 20 can be employed for displaying and viewing visual image content received from video conferencing device 16. Image content can be projected or displayed through optical assembly 22 to be viewed in conjunction with the real surrounding environment. Head mounted display assembly 20 can have (1) a single small display optic located in front of one of the user's eyes (monocular head mounted display), or (2) two small display optics, with each one being located in front of each of the users two eyes (bi-ocular head mounted display), for viewing visual display/image content by a single user. A bi-ocular head mounted display assembly 20 can provide the user visual content in three dimensions (3D). Head mounted display assembly 20 can include audio input and audio output 29 such as a microphone and speaker. Audio output and audio input 29 can be combined into a single module or as separate modules. Head mounted display assembly 20 (e.g., intelligent electronic glasses/headset) can provide continuous and always-on acquisition of audio, image, video, location and other content using a plurality of input sensors. For example, audio and video transmitters and receivers can be included on head mounted display assembly 20.

FIG. 3 illustrates a mobile location device 30 useful in a telepresence system according to one example of the present disclosure. Mobile location device 30 includes a housing 32, a drive mechanism 34, a power source 35, and a video capture device 36. Mobile location device 30 also includes a video transmitter, a processor, and a communication module. Housing 32 maintains and/or contains drive mechanism 34, power source 35, video capture device 36, video transmitter, processor, and communication module. Housing 32 is any desired shape and size as appropriate for the desired mobility and use of mobile location device 30.

Drive mechanism 34 can be mounted in or on housing 32 of mobile location device 30 to provide mobility of mobile location device 30 and navigation to and within a designation location. For example, remote first user can control navigation of mobile location device 30 by remotely controlling drive mechanism 34 using a controller via communication system established to a communication module. Mobile location device 30 can be a remotely navigate airborne device, such as a drone, for example. Drive mechanism 34 can include a motor (not shown) and an aerial propulsion mechanism (e.g., one or more propellers or rotors) to facilitate aerial movement, or a motor and wheels to facilitate ground movement, for example. Power source 35 supplies energy to drive mechanism 34, amongst other elements of mobile location device 30, to facilitate movement of mobile location device 30 within the real-world environmental surroundings. By navigating the mobile location device 30, the first user may make it appear that the representation of the first user is moving about the second user's environment.

Regardless of mobility means, mobile location device includes a video capture device 36 and communication and processing capabilities. Video capture device 36 can be a camera, for example. Images obtained with video capture device 36 can be still images or moving images of the environment surroundings. In some examples, multiple cameras can be used simultaneously or alternately to provide a 360 degree experience. In some examples, camera can be a 3D camera. Video capture device 36 can be still or movable (e.g., rotatable, zoomable) in response to command data received from video conferencing device or can be automated through programmed instructions, for example. Mobile location device 30, as physically separate and distinct from head mounted display assembly worn by second user, provides remote first user viewing of second user in a perspective of as if remote user were present in the environmental surroundings of first user. Video transmitter (not shown) transmits the images captured by video capture device 36 through communication system to video conferencing device (see, e.g., FIG. 1).

An audio input and output can be included in mobile location device 30 to input audio feed from second user and the environmental surroundings and output audio feed received from the remote user wirelessly transmitted through communication system. An input device, such as a microphone, for example, can capture audio input to be transmitted from the designated location. Audio and video inputs can be combined in a single module or device or be included as separate modules or devices. Communication module (not shown) can wireless transmit and receive at least one of data, audio, and video. Communication can include audio and video data as well as navigational and other data. Processor (not shown) is housed within housing 32 of mobile location device to process video, audio, and data including instruction commands related to movement of mobile location device 30. A memory can be included in mobile location device to store instructions and data, for example.

Mobility of the mobile location device 30 can provide flexibility to the telepresence system, allowing the telepresence system to be moved into and around a plurality of different environmental surroundings. Mobile location device 30 can have capabilities to move through air via independent operation and power. Mobile location device, as a drone, for example, can have a high control level, precise movements, and high definition cameras. Navigation and control of the mobile location device can be implemented by the remote user. Alternatively, or additionally, navigation and control of the mobile location device can be implemented by the present user. Mobile location device 30 can be movable in correspondence or in conjunction with the local user. For example, when the local user is walking along a sidewalk, mobile location device moves in the same direction and speed as the local user. In one example, mobile location device can track, or follow, the user moving within or through environmental surroundings.

Mobile location device 30 can be independently controlled, for example, mobile location device 30 can be remotely navigated by first user. Remote navigation and control of the mobile location device 30 can provide interactive engagement between users in location(s) remote from one another. In some examples, mobile location device 30 can be a remotely navigated airborne device, for example, a drone (i.e., unmanned aerial vehicle, UAV). Mobile location device 30 can be remotely controlled or operate autonomously via machine readable-controlled flight plans in embedded systems operating in conjunction with sensors and global positioning system (GPS), for example. Mobile location device 30 can be compact and operationally efficient for extended use without renewing power source 35. Power source 35 can be a battery or rechargeable battery, for example. Responsiveness to remote control commands, speed, agility, maneuverability, size, appearance, energy consumption, audio and visual input and output, and location sensors can be factors in selecting appropriate features including in mobile location device 30.

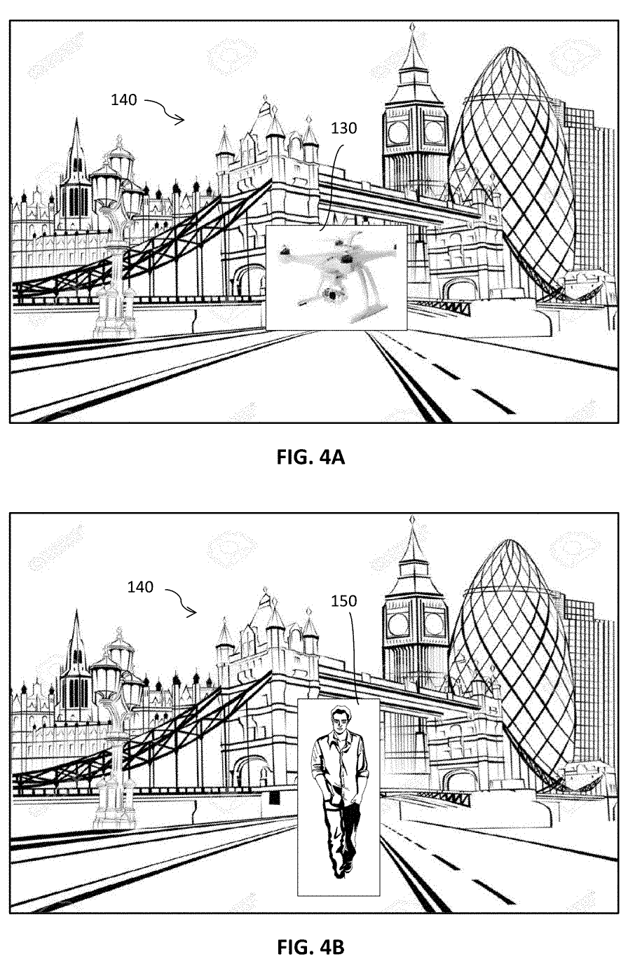

FIG. 4A is an illustration of a mobile location device 130 in an environmental surrounding 140. FIG. 4B is an illustration of mobile location device 130 in environmental surroundings 140 of FIG. 4A as viewed by a user wearing a head mounted display assembly in accordance with aspects of the present disclosure. As illustrated in FIG. 4A, mobile location device 130 can operate in environmental surroundings. Mobile location device 130 is visible to individuals within environmental surroundings in native form. As illustrated in FIG. 4B, an individual (e.g., second user) wearing a head mounted display assembly in accordance with aspects of the present disclosure, views a virtual image when the second user orientates head mounted display assembly toward mobile location device 130. Head mounted display is employed to visualize an image, such as an image 150 generated via video conferencing device representing first remote user, within second user's environmental surroundings when orientated toward mobile location device 130 (see also, e.g., FIGS. 1 and 2). For example, a virtual image 150 of first user is displayed as a hologram projected in relation to mobile location device 130, either directly in a location of mobile location device 130 or offset from mobile location device 130. For example, mobile location device 130 can be operated in airspace adjacently above second user and image content displayed at or near ground level. Spatial parameters of environmental surroundings 140 and positional information of mobile location device 130 can be correlated (continuously or intermediately) with virtual image 150 within environmental surroundings 140 and relative to mobile location device 130. In an example, the image 150 of the first user may be inserted into images displayed to the user by an augmented or virtual reality system. Second user and environmental surroundings 140 are viewed by remote first user at video conferencing device through a video capture device of mobile location device. The second user can interact with the remote first user in conversation as if in the same environmental surroundings through the telepresence system.

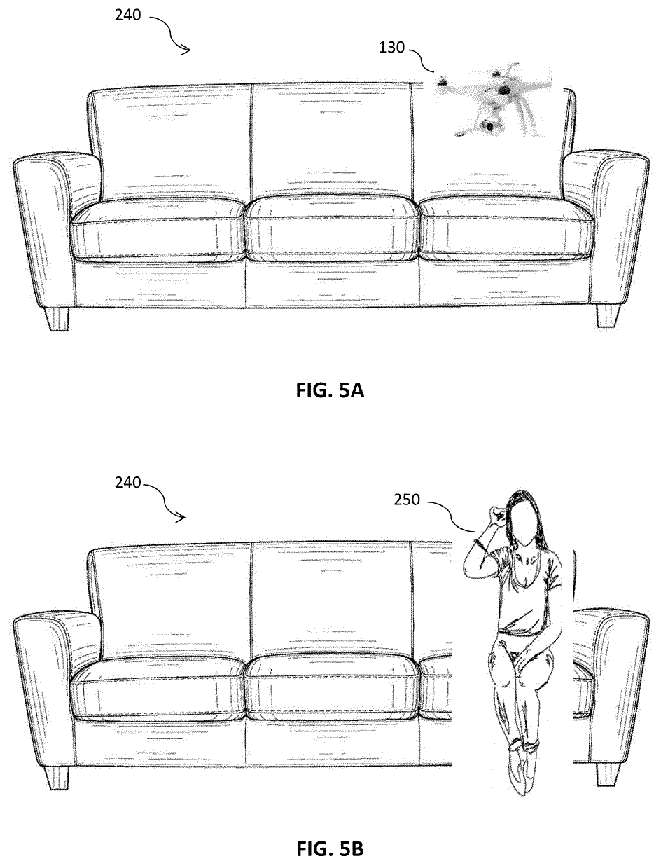

FIG. 5A is another illustration of mobile location device 130 in environmental surroundings 240. FIG. 5B is an illustration of mobile location device 130 in environmental surroundings 240 of FIG. 5A as viewed by a user wearing a head mounted display assembly in accordance with aspects of the present disclosure. Similar to FIG. 4A, FIG. 5A illustrates mobile location device 130 in native form, as visible to individuals viewing mobile location device without head mounted display assemblies. FIG. 5B illustrates an image, such as a virtual image 250, as projected or displayed over/on mobile location device 130 as viewed by a user through a head mounted display assembly. Virtual image 250 can include visual actions such as sitting or standing to interact with the second user and environmental surroundings 240. The second user can interact with the remote first user in conversation as if in the same environmental surroundings through the telepresence system.

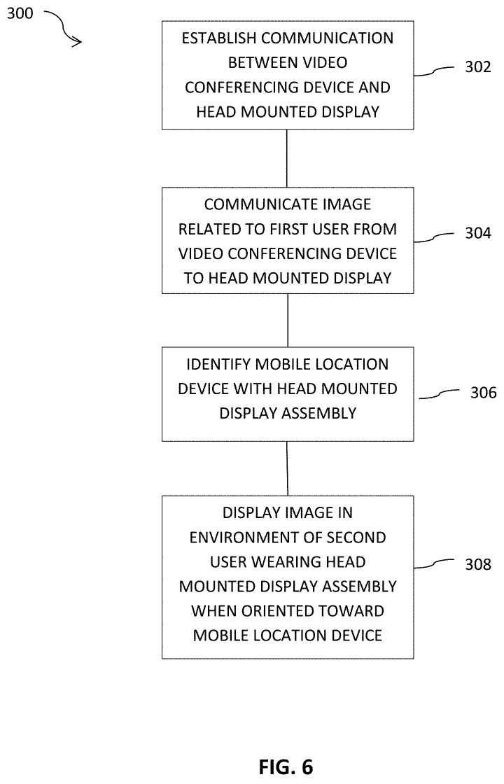

FIG. 6 illustrates a flow chart of an example method 300 of operating a telepresence system. At 302, communication between a video conferencing device and a head mounted display assembly is established. At 304, content related to a first user generated at the video conferencing device is communicated to the head mounted display assembly. At 306, a mobile location device is identified with the head mounted display assembly. At 308, the content related to the first user is displayed in an environment of the mobile location device when the head mounted display assembly is oriented toward the mobile location device. The content is viewable by a second user wearing the head mounted display assembly.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A telepresence system comprising:
a mobile location device; and
a head mounted display assembly to visualize an image representing a first user within a second user's environmental surroundings based on orientation toward the mobile location device, the head mounted display assembly to communicate with a video conferencing device via a wireless communication system.

2. The telepresence system of claim 1, wherein the image is an avatar image.

3. The telepresence system of claim 1, wherein the communication system wirelessly transmits data, audio, and video between the mobile location device, the head mounted display assembly, and the video conferencing device.

4. The telepresence system of claim 1, wherein the head mounted display assembly includes audio input and audio output modules.

5. The telepresence system of claim 1, wherein the video conferencing device includes an audio receiver and transmitter, a video receiver and transmitter, and a data input and output module.

6. The telepresence system of claim 1, wherein the mobile location device includes audio input and audio output modules.

7. The telepresence system of claim 1, wherein the mobile location device includes a video capture device and a video transmitter.

8. A head mounted display assembly useful in a telepresence system, the head mounted display assembly comprising:
an optical assembly to view at least a portion of a surrounding environment corresponding to a field of view of a first user and to display an image representing a remote user within the environmental surroundings of the first user based on orientation toward a mobile location device;
an image source to introduce the image to the optical assembly; and
a processor to process the image for display and to communicatively couple to the mobile location device and a video conferencing device.

9. The head mounted display assembly of claim 8, comprising:
an audio receiver to receive audio input from the remote user;
an audio module to receive audio input from the first user, and
an audio transmitter to communicate audio with a video conferencing device via a wireless communication system.

10. The head mounted display assembly of claim 8, comprising:
a sensor to acquire position information of the head mounted display assembly and the mobile location device.

11. The head mounted display assembly of claim 8, wherein the processor processes spatial parameters of the environmental surroundings and position information of the mobile location device to correspond the image within the environmental surroundings and relative to the mobile location device.

12. The head mounted display assembly of claim 8, comprising:
a communication module to transmit and receive at least one of data, audio, and video.

13. A method of operating a telepresence system comprising:
establishing communication between a video conferencing device and a head mounted display assembly;
communicating an image related to a first user generated at the video conferencing device to the head mounted display assembly;
identifying a mobile location device with the head mounted display assembly; and
displaying the image related to the first user in an environment of the mobile location device when the head mounted display assembly is oriented toward the mobile location device, the image viewable by a second user wearing the head mounted display assembly.

14. The method of claim 13, wherein displaying includes inserting the image at a location of the mobile location device in video of the environment provided to the second user.

15. The method of claim 13, comprising:
capturing images with the mobile location device; and
communicating images captured with the mobile location device to the video conferencing device.
